(19) United States
(12) Patent Application Publication
(10) Pub. No.: US 2015/0092912 A1
(43) Pub. Date: Apr. 2, 2015

(54) SYSTEMS AND METHODS FOR FILTERING EMISSIONS FROM SCINTILLATORS

(71) Applicant: General Electric Company, Schenectady, NY (US)

(72) Inventors: Haochuan Jiang, Milwaukee, WI (US); Anant Achyut Setlur, Niskayuna, NY (US); Robert Joseph Lyons, Niskayuna, NY (US); Kevin Alan David, Milwaukee, WI (US); James Edward Murphy, Niskayuna, NY (US); Vladimir Lobastov, Niskayuna, NY (US)

(73) Assignee: General Electric Company, Schenectady, NY (US)

(21) Appl. No.: 14/073,296

(22) Filed: Nov. 6, 2013

Related U.S. Application Data
(60) Provisional application No. 61/885,824, filed on Oct. 2, 2013.

(51) Int. Cl. G01T 1/20; G01N 23/04

(52) U.S. Cl. CPC G01T 1/2006; G01N 23/046
USPC 378/19; 250/361 R; 29/428; 250/367

(57) ABSTRACT

Systems and method for filtering emissions from scintillators are provided. One system includes a scintillator having a scintillator material portion formed from a base scintillator material. The scintillator also includes a photodetector and a filter portion, The filter portion includes a material blocking near-infrared (IR) emissions. The filter portion is disposed on a surface of one of the scintillator material portion or the photodetector, and wherein the scintillator material portion, the photodetector, and the filter portion are coupled together. The filter portion blocks the near-IR emissions from impinging on the photodetector.

### CROSS-REFERENCE TO RELATED APPLICATIONS

This application claims priority to and the benefit of the filing date of U.S. Provisional Application No. 61/885,824, filed on Oct. 2, 2013, entitled “Systems and Methods for Filtering Emissions from Scintillators,” which is hereby incorporated by reference in its entirety.

### BACKGROUND

Imaging systems, such as computed tomography (CT) or x-ray imaging systems, include an x-ray source positioned to emit x-rays toward a detector, and an object positioned therebetween. In CT imaging systems, the x-ray source emits a fan-shaped beam toward a subject or object, such as a patient or a piece of luggage. The x-ray source and the detector array may be rotated about the gantry within an imaging plane and around the subject. The x-ray source emits an x-ray beam that after being attenuated by the subject, impinges upon an array of x-ray detectors. The intensity of the attenuated beam radiation received at the detector array is typically dependent upon the attenuation of the x-ray beam by the subject and used to reconstruct an image.

Some x-ray detectors that use non-direction conversion materials include a collimator for collimating x-ray beams received at the detector, a scintillator for converting x-rays to light energy adjacent the collimator, and photodiodes for receiving the light energy from the adjacent scintillator and producing electrical signals therefrom. In order to achieve high-resolution images, the scintillator material is often diced into small pieces or cells and assembled in a pixilated array with a desired geometry prior to attaching to the photodiode. The scintillator material of a cell or element of the scintillator array converts x-rays to light energy. In particular, the scintillator material absorbs x-rays incident on that cell and discharges light energy (photons) to the photodiode adjacent thereto. Each photodiode detects the light energy and generates a corresponding electrical signal indicative of the attenuated beam received by each detector element.

Scintillators typically comprise a non-luminescent host material that has been modified by inclusion of an activator species that is present in the host material in a relatively low concentration. The host crystal absorbs the incident photon, and the absorbed energy may be accommodated by the activator ions, or may be transferred by the lattice to the activator ions. One or more electrons of the activator ions are raised to a more excited state. These electrons, in returning to a less excited state, emit a photon of luminescent light.

Solid state ceramic scintillators are also used as radiation detectors to detect penetrating radiation. The material properties of the scintillators vary greatly based on the specific chemical composition of the scintillator. These properties include scintillator efficiency, primary decay time, afterglow, hysteresis, luminescent spectrum, x-ray stopping power, and resistance to radiation damage. The efficiency of a luminescent material is the percentage of the energy of the absorbed stimulating radiation which is emitted as luminescent light. When the stimulating radiation is terminated, the luminescent output from a scintillator decreases in two stages. The first of these stages is a rapid decay from the full luminescent output to a low, but normally non-zero, value at which the slope of the decay changes to a substantially slower decay rate. This low intensity, normally long decay time luminescence, is known as afterglow. Afterglow provides a background luminescent intensity, which is a noise contribution to the photodetector output. In some cases, afterglow is increased by the presence of impurities, and in other cases, afterglow is decreased by the presence of impurities.

The initial, rapid decay is known as the primary decay or primary speed. Scan times of CT systems, which are the times required for a CT system to scan and acquire an image, are related to the primary decay time of the scintillator, such that shorter CT scan times require shorter scintillator decay times. As the speed of data processing in CT scanners increases it is desirable to have faster scintillators, i.e., shorter time between receipts of stimulating radiation pulses so to fully take advantage of the capability of the scanner. By reducing afterglow and increasing light output, CT detectors having improved resolution may be provided.

### BRIEF DESCRIPTION

In one embodiment, a scintillator is provided that includes a scintillator material portion formed from a base scintillator material. The scintillator also includes a photodetector and a filter portion, The filter portion includes a material blocking near-infrared (IR) emissions. The filter portion is disposed on a surface of one of the scintillator material portion or the photodetector, and wherein the scintillator material portion, the photodetector, and the filter portion are coupled together. The filter portion blocks the near-IR emissions from impinging on the photodetector.

In another embodiment, a method for providing a scintillator includes providing a scintillator material portion formed from a base scintillator material and providing a photodetector. The method also includes disposing a filter portion on a surface of one of the scintillator material portion or the photodetector, wherein the filter portion includes a material blocking near-infrared (IR) emissions. The method further includes coupling the scintillator material portion, the photodetector, and the filter portion together, and wherein the filter portion blocks the near-IR emissions from impinging on the photodetector.

### BRIEF DESCRIPTION OF THE DRAWINGS

FIG. 1 is a pictorial view of a computed tomography (CT) imaging system in which various embodiments may be implemented.

FIG. 2 is a schematic block diagram of the system illustrated in FIG. 1.

FIG. 3 is a perspective view of one embodiment of a CT system detector array in which various embodiments may be implemented.

FIG. 4 is a perspective view of one embodiment of a detector in which various embodiments may be implemented.

FIG. 5 is a schematic block diagram of a scintillator in accordance with an embodiment.

FIG. 6 is a schematic block diagram of a scintillator in accordance with another embodiment.

FIG. 7 is a schematic block diagram of a scintillator in accordance with another embodiment.

FIG. 8 is a graph of photoluminescence spectra in accordance with an embodiment.

FIG. 9 is a graph of afterglow intensity in accordance with various embodiments.

FIG. 10 is a graph of absorbances for different dyes that may be implemented in various embodiments.

FIG. 11 is a flowchart of a method for providing a scintillator with reduced afterglow in accordance with various embodiments.

FIG. 12 is a pictorial view of a CT system for use with a non-invasive package inspection system in which various embodiments may be implemented.

### DETAILED DESCRIPTION

The following detailed description of certain embodiments will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Although the various embodiments may be described herein within a particular operating environment, for example in connection with a particular imaging system, it should be appreciated that one or more embodiments are equally applicable for use with other configurations and systems. For example, the various embodiments may be used in different medical and non-medical applications

For example, various embodiments are described below with respect to the detection and conversion of x-rays. However, various embodiments are equally applicable for the detection and conversion of other high frequency electromagnetic energy. Further, the operating environment is described herein with respect to a “third generation” CT scanner and sixty-four-slice computed tomography (CT) system. However, those skilled in the art will appreciate that various embodiments are equally applicable for use with other multi-slice configurations and other CT systems. Thus, although a medical CT imaging system is described below with respect to various embodiments, it should be recognized that embodiments are equally applicable to various alternate medical and industrial imaging systems including security and industrial CT applications, nuclear physics and outer space exploration applications, downhole drilling for oil and gas exploration, positron emission tomography (PET), digital radiography, and other x-ray, gamma radiation, ultra-violet radiation, and nuclear radiation detecting applications.

In accordance with some embodiments, a garnet based ceramic scintillator material is provided in combination with a material that absorbs or reflects wavelengths outside of the Ce³⁺ emission range. More specifically, in some embodiments, the scintillator has a composition of a rare earth-activated garnet containing gadolinium and yttrium as described in more detail herein and the filter material is a material that effectively transmits the Ce³⁺ emission (approximately 450-700 nm) while absorbing or reflecting radiation at wavelengths longer (or shorter) than approximately 700 nm. In various embodiments, the filter material may be, for example, coupled or placed on top of the photodiode, directly attached to the back of the scintillator, or embedded in the optical coupling material. Thus, in various embodiments, the filter material is not added to nor forms part of the scintillator material. In particular, the scintillator material in various embodiments is not changed or modified, but instead a filter material and/or filter device is separately provided.

The filter material may be composed, for example, of commercial filters capable of filtering certain wavelengths as well as organic dyes, pigments, nanomaterials including nano-sized noble metals and semiconductors, among others as described herein. In various embodiments, the filter material decreases afterglow in scintillators which show emission due to, for example, iron and chromium.

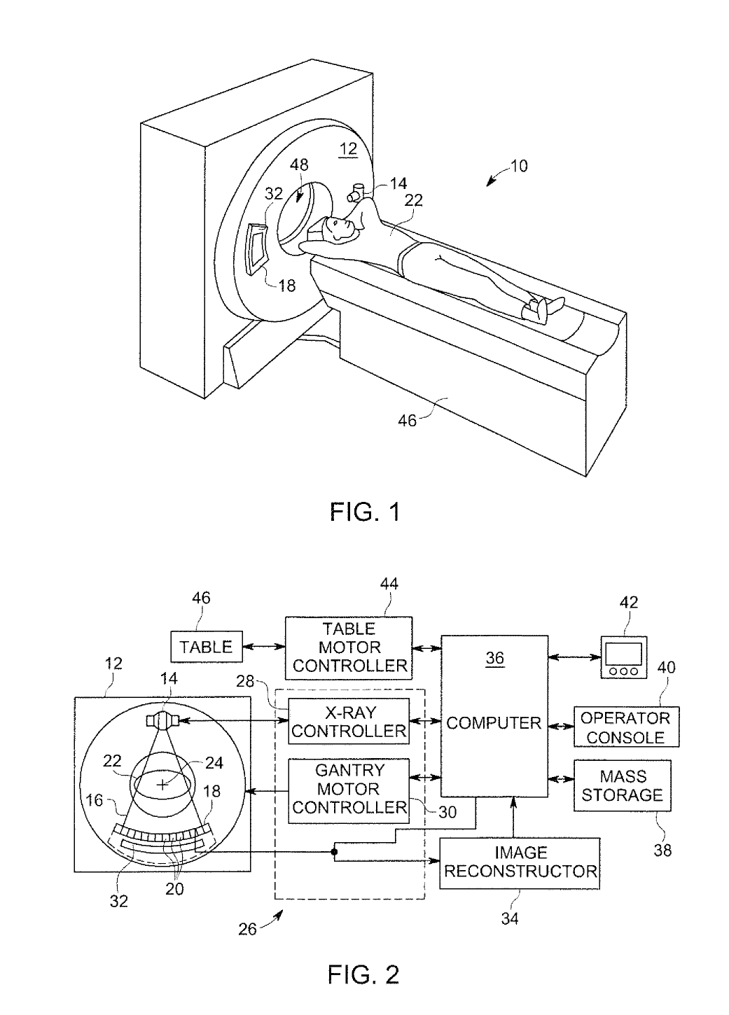

The scintillator material and filter combination of various embodiments may be used with, for example, detectors of different imaging systems. For example, FIG. 1 illustrates a computed tomography (CT) imaging system 10 in which various embodiments may be implemented. The CT imaging system is shown as including a gantry 12 representative of a “third generation” CT scanner. The gantry 12 has an x-ray source 14 that projects a beam of x-rays toward a detector assembly or collimator 18 on the opposite side of the gantry 12. Referring now to FIG. 2, the detector assembly 18 is formed by a plurality of detectors 20 and data acquisition systems (DAS) 32. The plurality of detectors 20 sense the projected x-rays 16 that pass through, for example, a medical patient 22, and the DAS 32 converts the data to digital signals for subsequent processing. Each detector 20 produces an analog electrical signal that represents the intensity of an impinging x-ray beam and hence the attenuated beam as the x-ray beam passes through the patient 22. During a scan to acquire x-ray projection data, the gantry 12 and the components mounted thereon rotate about a center of rotation 24.

Rotation of the gantry 12 and the operation of the x-ray source 14 are governed by a control mechanism 26 of the CT system 10. The control mechanism 26 includes an x-ray controller 28 that provides power and timing signals to the x-ray source 14 and a gantry motor controller 30 that controls the rotational speed and position of the gantry 12. An image reconstructor 34 receives sampled and digitized x-ray data from the DAS 32 and performs image reconstruction (e.g., high speed reconstruction). The reconstructed image is applied as an input to a computer 36, which stores the image in a mass storage device 38.

The computer 36 also receives commands and scanning parameters from an operator via the console 40 that has some form of operator interface, such as a keyboard, mouse, voice activated controller, or any other suitable input apparatus. An associated display 42 allows the operator to view the reconstructed image and other data from the computer 36. The operator supplied commands and parameters are used by the computer 36 to provide control signals and information to the DAS 32, x-ray controller 28 and gantry motor controller 30. In addition, the computer 36 operates a table motor controller 44, which controls a motorized table 46 to position the patient 22 and the gantry 12. Particularly, the table 46 moves the patient 22 through a gantry opening 48 in whole or in part.

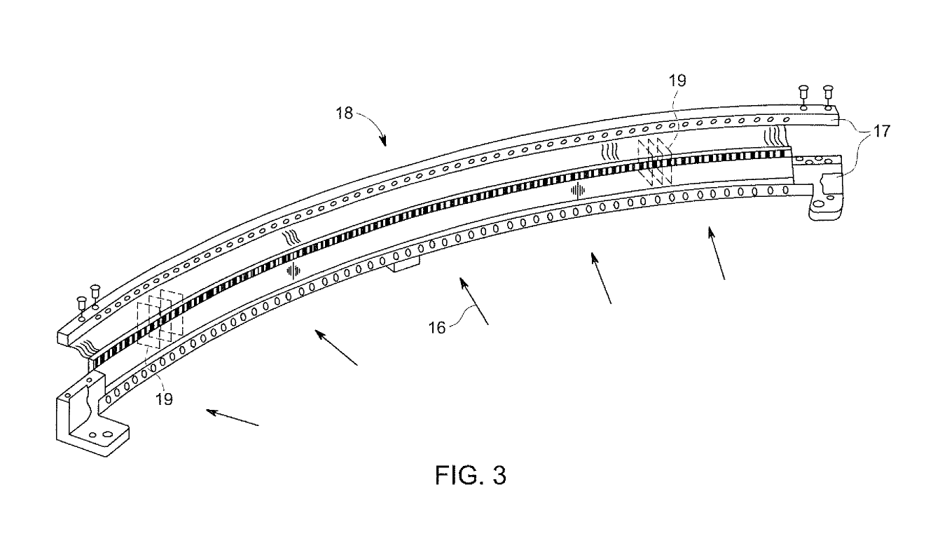

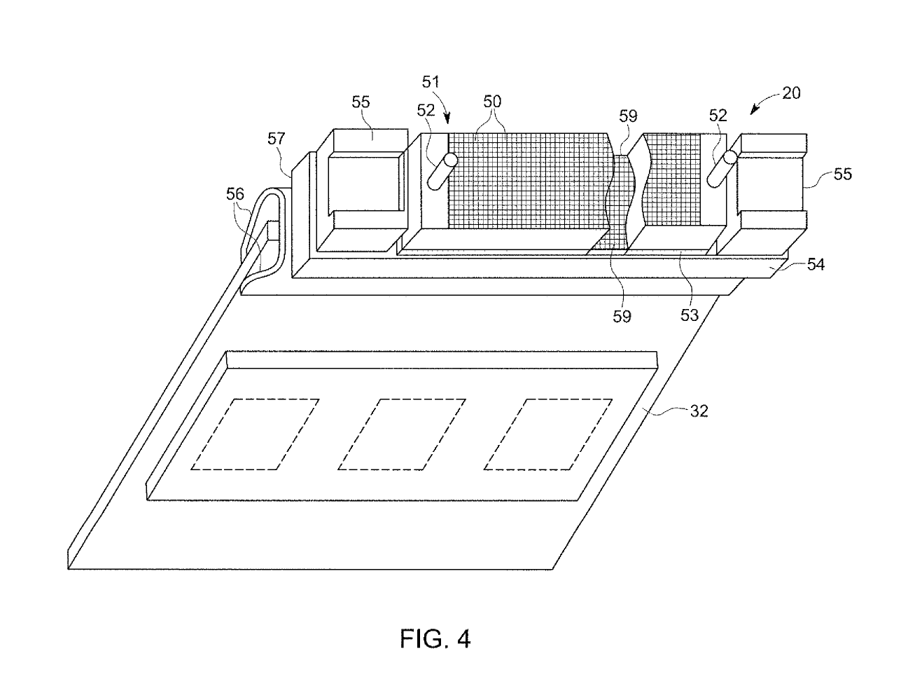

As shown in FIG. 3, the detector assembly 18 includes rails 17 having collimating blades or plates 19 placed therebetween. The plates 19 are positioned to collimate x-rays 16 before such beams impinge upon, for instance, the detector 20 of FIG. 4 positioned on the detector assembly 18. In one embodiment, the detector assembly 18 includes 57 detectors 20, each detector 20 having an array size of 64×16 of scintillator or pixel elements 50. As a result, the detector assembly 18 has 64 rows and 912 columns (16×57 detectors) which, allows 64 simultaneous slices of data to be collected with each rotation of the gantry 12. However, other configurations are contemplated.

Referring particularly to FIG. 4, the detector 20 includes the DAS 32, with each detector 20 including a number of scintillator elements 50 arranged in a pack 51. The detectors 20 include pins 52 positioned within the pack 51 relative to the scintillator elements 50. The pack 51 is positioned on a backlit diode array 53 having a plurality of diodes 59. The backlit diode array 53 is in turn positioned on a multi-layer substrate 54. Additionally, spacers 55 are positioned on the multi-layer substrate 54. The scintillator elements 50 are optically coupled to the backlit diode array 53, and the backlit diode array 53 is in turn electrically coupled to the multi-layer substrate 54. Flex circuits 56 are attached to the face 57 of multi-layer substrate 54 and to the DAS 32. The detectors 20 are positioned within the detector assembly 18 by use of, for example, the pins 52.

In the operation of one embodiment, x-rays impinging within the scintillator elements 50 generate photons which traverse the pack 51, thereby generating an analog signal which is detected on a diode within the backlit diode array 53. The analog signal generated is carried through the multi-layer substrate 54, through the flex circuits 56, to the DAS 32 wherein the analog signal is converted to a digital signal.

According to various embodiments, the scintillator elements 50 comprise a scintillator composition having a garnet structure activated with a rare earth metal ion and which includes a filter, for example, an afterglow reducing filter, such as a Cerium (Ce) filter as described herein (e.g., a Ce³⁺ filter). The scintillator composition is efficiently excitable by x-radiation and efficiently emits light for detection by the photodiodes 59 of diode array 53. In one embodiment, the scintillator elements 50 are responsive to x-ray excitation and have high light output, reduced afterglow, enhanced stability under radiation, and/or high x-ray stopping power. It should be noted that in some embodiments, all metals disclosed herein are present in the scintillator compositions in combined form, usually as the oxide, rather than in elemental form. As used herein in various embodiments the term “scintillator” refers to a solid-state luminescent material that emits visible light in response to stimulation by high-energy radiation such as X, β, or γ radiation.

The scintillator composition of some embodiments is a rare earth-activated garnet containing gadolinium and yttrium, and has a general formula of:

(Gd_{1-x-y-z}YₓA_{y}Ce_{z})₃₊ᵤ(Ga₁₋ₘ₋ₙAlₘDₙ)₅₋ᵤO₁₂:wFO,

wherein A is at least one member selected from the group consisting of lutetium, lanthanum, terbium, and dysprosium; D is at least one member selected from the group consisting of indium and scandium; F is at least one member selected from the group consisting a divalent ion other than magnesium, such as of calcium, strontium, barium, zinc, and/or nickel; z is in the range from about 0.001 to and including 0.05; x is in the range from and including zero to 0.2; y is in the range from zero to 0.5; u is in the range from zero to 0.1; n is in the range from and including zero to 0.2; m is in the range from about 0.3 to 0.6; and w is in the range from and including about 10 ppm (mass) to and including 300 ppm (mass). The ratio of y to x is greater than 1. In one embodiment, x is in the range from 0.05 to 0.2, and y is in the range from 0.05 to 0.5.

In one embodiment, the scintillator is activated with cerium and has an emission band that is centered around approximately 560 nanometers (nm). Due to the fast transition of cerium, the decay speed of this scintillator is very fast with a primary decay time less than 200 nanoseconds (ns) in some embodiments. It should be appreciated that while various embodiments are described herein using cerium as the activator, alternate rare earth metals such as, for example, praseodymium or neodymium, may be used.

In some embodiments, the inclusion of yttrium, lutetium, dysprosium, and/or terbium in the scintillator composition yields improved stability of the cubic garnet structure over a gadolinium scintillator. Gadolinium has a larger ionic radius than yttrium, lutetium, dysprosium, or terbium and tends to promote a perovskite structure (GdAlO3). However, too much perovskite phase in the scintillator composition leads to undesirable scintillator properties including lower transparency, lower light output due to light scatter, and less uniform material. The addition of one or more elements having a smaller ionic radius, such as yttrium, lutetium, terbium, or dysprosium, helps retain and stabilize the garnet structure.

In one embodiment, the scintillator is a lutetium gadolinium aluminum gallium garnet activated with cerium doped with calcium oxide having the formula Gd_{2.849}Lu_{0.15}Ce_{0.005}Ga_{1.998}Al_{2.998}O₁₂:(25-100 ppm)CaO. In some embodiments, the scintillator composition has the formula (Gd_{1-x-y-z}YₓA_{y}Ce_{z})₃₊ᵤ(Ga₁₋ₘ₋ₙAlₘDₙ)₅₋ᵤO₁₂:wSrO where x, y, z, u, m, and n take the values as defined herein and w is in the range from 10 ppm to 300 ppm.

Various embodiments provide a scintillator with a filter arrangement that reduces afterglow, such as for the scintillator materials described herein. In some embodiments, the scintillator material may be provided as described in co-pending application Ser. No. 13/448,779, entitled “Rare Earth Garnet Scintillator And Method of Making Same”, which is hereby incorporated by reference in its entirety.

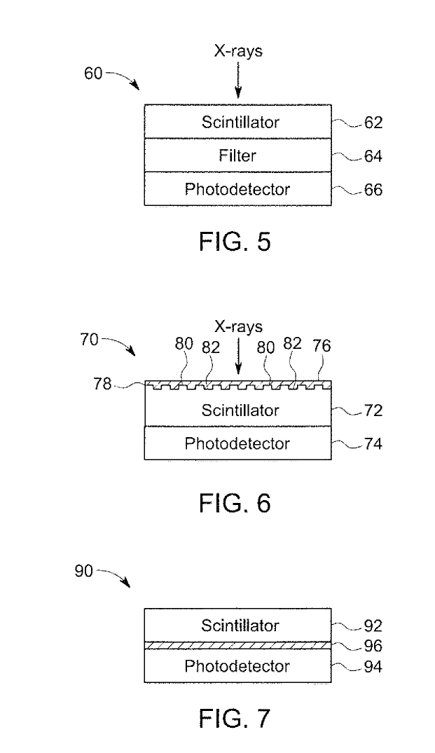

The scintillator in various embodiments includes a filter or filter portion that is separate from and coupled to (e.g., deposited or adhered) photodiode or the scintillator material without integrating with or changing the structure (e.g., chemical structure) of the scintillator material. For example, a filter component or material may be positioned adjacent the scintillator material to filter certain scintillator emissions, such as positioned along or on (and/or abutting) one or more surfaces of the scintillator material (e.g., scintillator substrate). In one embodiment, for example as illustrated in FIG. 5, a scintillator 60 may be provided in a multi-layered arrangement or structure. It should be noted that the positioning and relative dimensions (e.g., thicknesses) of the various components are shown merely for example and may be varied as desired or needed.

In some embodiments, the scintillator 60 includes a scintillator material portion 62, illustrated as a scintillator layer that is positioned adjacent a filter portion 64, illustrated as a filter layer. For example, the filter portion 64 may be coupled to and in adjacent relationship with the scintillator material portion 62. In some embodiments, the filter portion 64 is a material layer that is deposited, formed, or otherwise provided along a surface of the scintillator material portion 62. The filter portion 64 may be provided along all or some of the surface of the scintillator material portion 62 as described in more detail herein. Thus, in various embodiments, the filter portion 62 overlays a surface or face of the scintillator material portion 62. For example, in some embodiments, the filter portion 64 is applied, for example, using a non-line of sight process, such as chemical vapor deposition, physical vapor deposition, sputtering, via chemical reduction from a liquid phase or gas phase metallization to the scintillator material portion 62. As described in more detail herein, the filter portion 64 may also be provided along the surface of the scintillator material portion 62, such as when performing a pixelating process on the scintillator material portion 62.

In the illustrated embodiment, the filter portion 62 is provided between the scintillator material portion 62 and a photodetector portion 66, for example, as an intermediate layer sandwiched between the scintillator material portion 62 and the photodetector portion 66, which is illustrated as a photodetector layer. However, different configurations are contemplated as described herein. It should be noted that the filter portion 64 may similarly be first coupled or provided on or to the photodetector portion 66 as described above and then coupled to the scintillator material portion 62.

The photodetector portion 66 may be embodied, for example, as the photodiodes 59 of diode array 53 as described in more detail herein. The photodetector portion 66 may be provided along a surface of the filter portion 62 as described in more detail herein with respect to the filter portion 64 being coupled to the scintillator portion 62. In general, in various embodiments, the multi-layer structure may be formed using different suitable manufacturing or fabrication processes that allows the layers to be physically separate layers in adjacent relationship (e.g., abutting relationship) to each other.

As should be appreciated, the detecting surface of the scintillator 60 is located at the top of the multi-layer structure shown in FIG. 5, with x-rays impinging thereon as illustrated by the arrow. In one embodiment, the scintillator portion 62 and photodetector portion 66 are formed using a suitable process, for example, as described herein, and the filter portion 64 is configured to reduce, prevent or block scintillator emission in the near infrared (IR) from reaching the photodetector portion 66 (e.g., photodiode detector). For example, emission in this region (e.g., Fe³⁺, Cr³⁺) often has a much longer radiative decay lifetime than Ce³⁺ emission so contributes significantly to undesirable afterglow in scintillators. In one embodiment, by selecting a filtering material that transmits the emission due to Ce³⁺ between approximately 450-700 nm while absorbing or reflecting emission outside of this region, a scintillator having improved light output with lower afterglow may be provided. For example, the filter portion 64 may be a suitable near-IR cut-off or blocking filter that blocks transmission in the near-IR frequency range. It should be noted that the filter portion 64 may be selected to block a particular frequency range, which may be approximately 450-700 nm. However, in other embodiments, the range may be varied to include higher or lower frequencies, or a larger or smaller range of frequencies, such as based on the type of material(s) used to form the scintillator portion 62. In various embodiments, the filter portion 62 is configured to block or reflect within the desired frequency range. Thus, in various embodiments, the filter portion 64 may be formed from a filtering material or device (e.g., 700 nm short pass filter) to block or reflect within the desired frequency range. In the illustrated embodiment, the filter material is placed or provided on top of the photodetector portion 66 and underneath the scintillator portion 62 as viewed in FIG. 5.

However, it should be appreciated that variations and modifications are contemplated. For example, the filtering material in some embodiments may consist of powders, dispersions or solutions which may be deposited onto the photodetector or scintillator material by a variety of techniques such as sputtering, drop casting, spray coating, doctor blading, spin coating, CVD, etc. For example, FIG. 6 illustrates a scintillator 70 having a scintillator portion 72 provided adjacent a photodetector portion 74 in a layered arrangement. In this embodiment, however, the filter portion 76 is provided on or along the detecting face 78 of the scintillator portion 72 (illustrated on top of the scintillator portion 72 as viewed in FIG. 6). For example, the detector portion 76 may be a material applied to the detecting face 78.

As can be seen, in the illustrated embodiment, the detecting face 78 is not planar, but instead in includes a pixelated structure. For example, a plurality of pixel elements 80 may be formed (e.g., etched or diced) on the detecting face 78 that includes gaps 82 therebetween. For example, the substrate forming the scintillator portion 72 may undergo one or more pixelating processes to define a number of pixel elements 80 in the substrate that form two-dimensional pixels. For example, the substrate may be diced using a wire saw dicer or other dicing mechanism. Additionally, the individual pixel elements 80 may be defined using ion beam milling, chemical etching, vapor deposition, or any other suitable substrate cutting technique. The individual pixel element 80 thus have the gaps 82 formed between pixel elements 80. In some embodiments, the gaps 82 extend between pixel elements 80 in both the x and z directions and have a width. The depth of the gaps 82 may be provided, for example, based on the stopping power desired and varies according to scintillator substrate composition. Thus, in some embodiments, for example, the scintillator 70 may be formed as a pixelated structure cut from a wafer.

In one embodiment, the filter portion 76 overlays the pixel elements 80 as well as the gaps 82, illustrated as filling in the gaps 82, which may entirely fill the gaps 82 or coat the gaps 82 (while not entirely filling the gaps 82). For example, the filter portion 76 may be deposited and filled into all of the gaps 82. After the filter portion 76 is overlayed on the scintillator portion 72, the top surface may be, for example, ground or milled to remove any extra material and provide a planar face. Again, it should be noted that while the material of the filter portion 76 abuts the scintillator portion 72, the material is not deposited into the material or substrate forming the scintillator portion 72.

As another example, a scintillator 90 is illustrated in FIG. 7 wherein a filter portion 96 is a filtering material that is mixed into the optical coupling resin or cast such that the filter portion 96 is between a scintillator material 92 and a photodetector 94. In this embodiment, the filter portion 96 forms part of the coupling resin, for example, but again does not form part of either the scintillator material 92 or the photodetector 94. In particular, the filter portion 96 does not implant or absorb into the scintillator material 92 or the photodetector 94. It should be noted that powders, dispersions and/or solutions may serve as filtering materials and include, but are not limited, to organic dyes, pigments, nanomaterials of noble metals such as Au, Pt, Pd, semiconductor nanocrystals, and oxide containing sol gel suspensions. However, other filtering materials may be used.

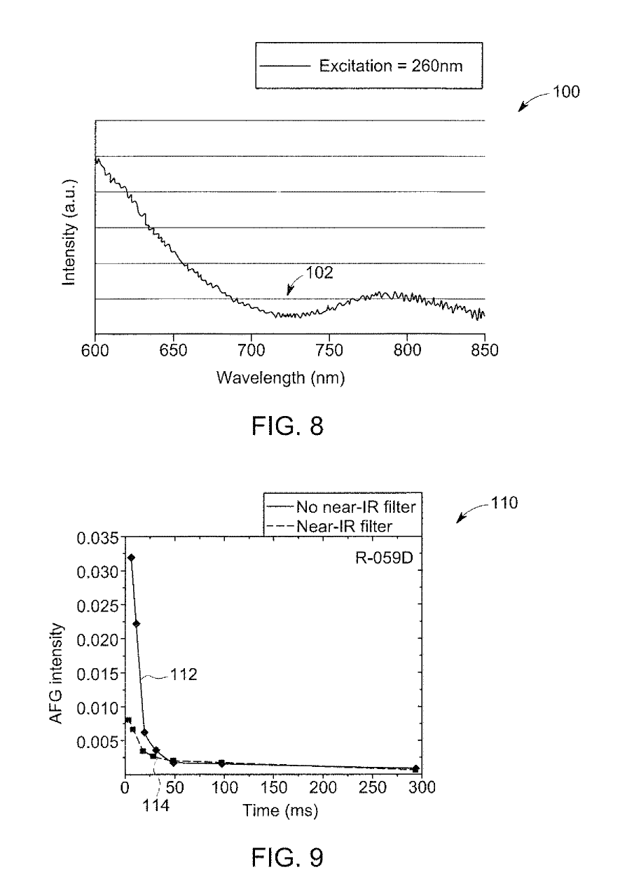

FIG. 8 is a graph 100 showing the photoluminescence spectra of (Lu, Gd, Ce)₃(Al,Ga)₅O₁₂ containing small amounts of iron contamination under steady-state 260 nm excitation. In the graph 100, the horizontal axis corresponds to wavelength and the vertical axis corresponds to intensity (which is illustrated in absorption units (a.u.)). As can be seen by the curve 102, the emission due to Ce³⁺ is apparent on the high energy side of the graph 100 out to approximately 700 nm. An emission characteristic of Fe³⁺ peak at about 790 nm is also evident in this spectrum. The Ce³⁺ emission has a radiative lifetime of less than 50 ns while emission due to Fe³⁺ has a much longer radiative lifetime of approximately 5 ms.

FIG. 9 is a graph 110 showing the afterglow results of the wafer having the results in the graph 102 (in FIG. 8) measured (60 kVP) both with and without a filter portion as described in herein. The horizontal axis corresponds to time in milliseconds (ms) and the vertical axis corresponds to afterglow (AFG) intensity. In particular, the filter used to generate the results of the curve 114 was a near-IR filter, which in this embodiment was a 700 nm short pass filter (Newport 10SWF-700B) available from Newport Corporation of Irvine, Calif. The curve 112 shows the results without the near-IR filter. It should be noted that the near-IR filter for the illustrated results may be the filter portion 64 as shown in FIG. 5 that is positioned between the scintillator material 62 and the photodetector 66. As can be seen in the graph 110, at short radiative decay times (<50 ms) the afterglow of the scintillator is reduced by a factor of 3 using the short pass filter. It should be noted that different filters or filters tuned to different frequencies may be used. In various embodiments, the filter allows visible emissions and blocks undesirable emissions, such as near IR transmissions. The cut off range or value for the blocking may be varied as desired or needed, for example, alternatively or optionally below about 450 nm. However, other ranges are contemplated.

The filtering of various embodiments is provided without modifying, for example, adding any intentional deposits into the scintillator material as synthesized, which can reduce quantum efficiency (e.g., less light produced) because the absorbed energy is remitted as heat. Thus, in some embodiments, the filter material is selected to have certain blocking characteristics. For example, some embodiments may use a dye that has no IR absorption below 700 nm and high absorbance (e.g., 80% or greater) from 725-875 nm. In various embodiments, the dye has a high solubility in optical coupler epoxy and low absorbance (e.g., less than 10%) from 575-675 nm. For example, in various embodiments, a near IR dye, such as Epolight™ available from Innovadex of Overland Park, Kans., may be used. In various embodiments, different Epolight dyes may be used, such as Epolight 3030, 3063, 3030 plus 3063, 3442, 4121, 4148, 4159, and 9151, among others, and combinations thereof. For example, one of more of these dyes may be applied within a chloroform solution. In some embodiments, a combination of the dyes is used, such as Epolight 9151 to cut off some of the long wavelength, Epolight 5810 to cut off wavelengths between 800-825 nm, Epolight 5810 to reduce bleed-through from Epolight 9151, and/or give Epolight 3442 additional absorption in this spectral region. For example, in one embodiment, the following combination or blends may be used: Epolight 5810, which has excellent absorption between 800-825 nm, and is combined with Epolight 5548 that has high absorption between 725-800 nm.

Other variations and materials may be used. For example, in one embodiment, Epolight 5588 in acetone may be used. Thus, depending on the particular absorptions desired or needed and the efficiency of blocking of the particular dye, mixtures or combinations may be used. For example, when using Epolight 5810 in chloroform, Epolight 5548 is also used to provide complete coverage within the Fe³ emission range.

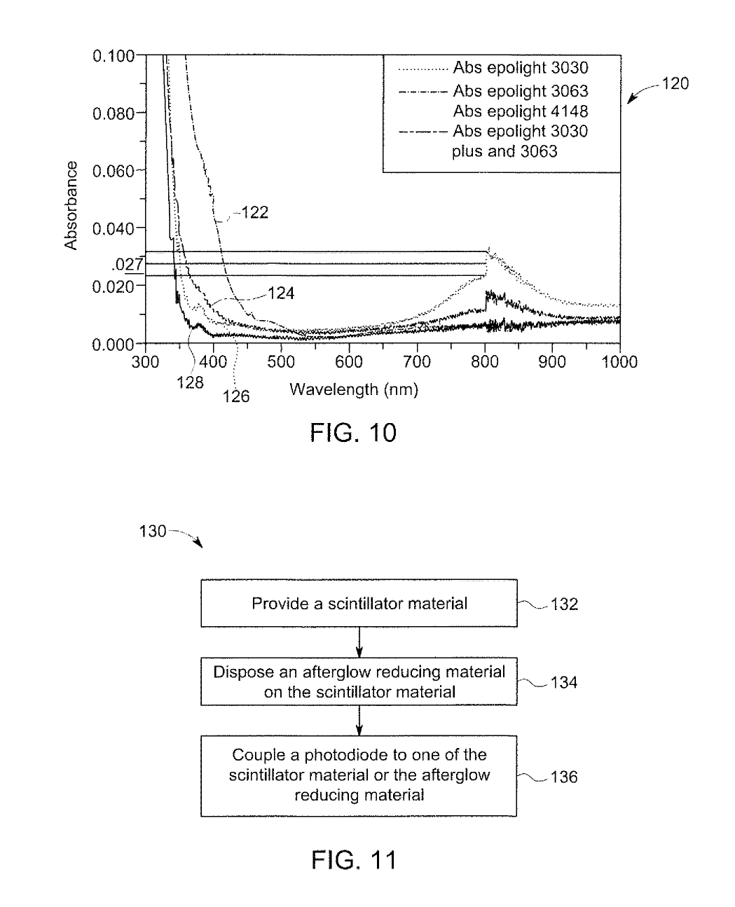

The graph 120 of FIG. 10 shows various results from the Epolight dyes, where the horizontal axis corresponds to wavelength and the vertical axis corresponds to absorbance. In particular, the curve 122 corresponds to Epolight 3063, the curve 124 corresponds to Epolight 3030 plus 3063, the curve 126 corresponds to Epolight 3030, and the curve 128 corresponds to Epolight 4148. It should be noted that the absorbance spectra are calculated from the collected total transmission and total reflectance spectra for each sample. Additionally, it should be noted that the bump in the spectra at 800 nm is due to grating/detector switchover.

The results in FIG. 10 were generated using the following:

The cast reflector is composed of two parts A and B. Part A is 44% loaded by weight TiO₂, mm that was cleaned with 200 nm TiO₂ particles (DuPont R960) (density 4.26) in Epotek 301 epoxy. Part A (density=1.12) also contains dispersant and Cr₂O₃(1.6 μm from Elementis) in 1,4 butanediol digylcidyl (1-10%) and the reaction product of epichlorohydrin and bisphenol A (65-85%). Part A makes up 80% by mass of the formulation. Part B (density 0.89) is composed of 2,2,4-trimethyl-1,6-hexanediamine (75-100% diamine in bottle, 20% by weight of formulation).

The following parameters were also used:

0.8*1.12+0.2*0.89=0.896+0.178=1.074 epoxy density uncured

44 g TiO2*1 ml/4.26 g=10.3286 mls=2.46E 15 particles in 62.47 cm̂3*1E12 micronŝ3/cm̂3

56 g epoxy*1 ml/1.074=52.141 mls

V=4/3Pr³

r=100 nm=0.1 micron=0.00001 cm

V=4.19E-15 cm³

It should be noted that the cast reflector reflects 80% of the light where 2.6% of the light comes from cross-talk.

Additionally, the following parameters applied to the experimental results:

Sphere Diameter 0.2 microns

Refractive Index of Medium 1.569

Real Refractive Index of Sphere 2.76

Imaginary Refractive Index of Sphere 0

Wavelength in Vacuum 0.55 microns

Concentration 39 spheres/micron3.

The following operating parameters also resulted:

| Wavelength in Medium | 0.35054 | microns |
|---|---|---|
| Size Parameter | 1.7924 | |
| Average Cosine of Phase Function | 0.52909 | |
| Scattering Efficiency | 3.1888 | |
| Extinction Efficiency | 3.1888 | |
| Backscattering Efficiency | 0.52174 | |
| Scattering Cross Section | 0.10018 | micron² |
| Extinction Cross Section | 0.10018 | micron² |
| Backscattering Cross Section | 0.016391 | micron² |
| Scattering Coefficient | 3907 | mm⁻¹ |
| Total Attenuation Coefficient | 3907 | mm⁻¹ |

Thus, in operation, by filtering out slower emission components of Ce³⁺ containing garnet scintillators, the measured afterglow decreased significantly. Accordingly, in various embodiments, CT detectors containing scintillators with reduced or minimal afterglow and higher light output may be provided such that high resolution CT imaging systems with high gantry speeds using a wider variety of scintillator materials may be provided. For example, the measured afterglow of a given cerium containing garnet material may be reduced by filtering out slower decaying radiative components in the near infrared.

FIG. 11 illustrates a flowchart of a method 130 for providing a scintillator with reduced afterglow. In various embodiments, the method 130, for example, may employ structures or aspects of various embodiments (e.g., structures, systems and/or methods) discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the method 130 may be able to be used as one or more algorithms to direct hardware to perform operations described herein.

The method 130 includes providing a scintillator material at 132. For example, a wafer or other substrate may be provided as described herein that is formed, such as from a scintillator composition of a rare earth-activated garnet containing gadolinium and yttrium. The scintillator material may be processed to form a pixelated structure as described herein.

The method 130 also includes disposing an afterglow reducing material on the scintillator material at 134 (or a photodetector). For example, as described herein, various methods may be used to couple or provide the afterglow reducing material on a surface of the scintillator material (or photodetector). In some embodiments, the afterglow reducing material is a near-IR blocking or cut-off material that may be applied to a surface of the scintillator material (or photodetector). However, it should be noted that in various embodiments, the base scintillator material is not changed. For example, there are no materials or deposits made within the scintillator material, but instead only to a surface thereof and not penetrating therein (e.g., scintillator material structure not changed or affected such that the scintillator material is not modified). However, in some embodiments, some incidental penetration may result, but there is no intentional deposits within the scintillator based material before, during or after the scintillator material is formed.

The method 130 further includes coupling a photodiode to one of the scintillator material or the afterglow reducing material. For example, as described herein, a multi-layer structure may be provided, with the different layers positioned at different locations relative to each other. Thus, the scintillator material portion, the photodetector, and the filter portion are coupled together.

Thus, various embodiments provide a scintillator having reduced afterglow that is formed without deposits or other modifications to the scintillator material. For example, an afterglow reducing material may be applied to one or more surfaces of the scintillator material or photodiode.

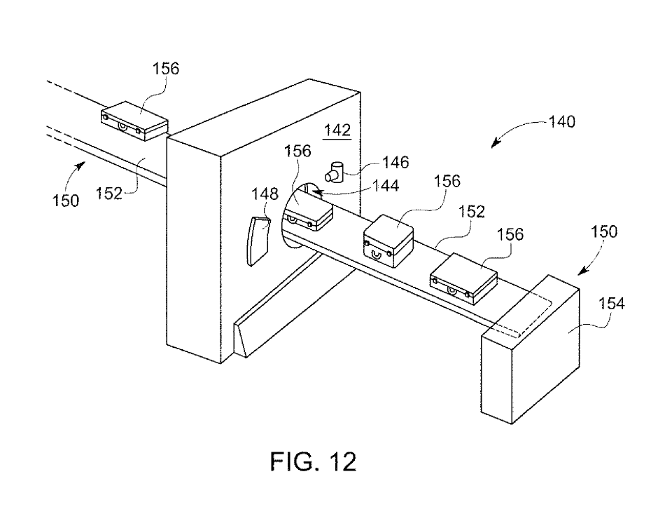

It should be noted that various embodiments may be implemented in detectors in different types of systems. For example, FIG. 12 illustrates a package/baggage inspection system 140 in which various embodiments may be implemented. The package/baggage inspection system 140 includes a rotatable gantry 142 having an opening 144 therein through which packages or pieces of baggage may pass. The rotatable gantry 142 houses a high frequency electromagnetic energy source 146 as well as a detector assembly 148 having scintillator arrays comprised of scintillator cells similar to that shown in FIGS. 3 and 4, and including the filter portion as described herein. A conveyor system 150 is also provided and includes a conveyor belt 152 supported by a structure 154 to automatically and continuously pass objects 156, such as packages or baggage pieces through the opening 144 to be scanned. The objects 156 are fed through opening 144 by the conveyor belt 152, imaging data is then acquired, and the conveyor belt 152 removes the packages 156 from opening 144 in a controlled and continuous manner. As a result, for example, postal inspectors, baggage handlers, and other security personnel may non-invasively inspect the contents of objects 156 for explosives, knives, guns, contraband, etc.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid state drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software and which may be embodied as a tangible and/or non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory. EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, the embodiments are by no means limiting and are exemplary embodiments. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A scintillator comprising:
a scintillator material portion formed from a base scintillator material;
a photodetector; and
a filter portion comprising a material blocking near-infrared (IR) emissions, the filter portion disposed on a surface of one of the scintillator material portion or the photodetector, wherein the scintillator material portion, the photodetector, and the filter portion are coupled together, and the filter portion blocks the near-IR emissions from impinging on the photodetector.

2. The scintillator of claim 1, wherein the filter portion is formed from a material that blocks emissions outside of a frequency range of approximately 450 nanometers (nm) to approximately 700 nm.

3. The scintillator of claim 1, wherein the filter portion is formed from a material that blocks emissions outside of a Ce³⁺ emission range.

4. The scintillator of claim 1, further comprising an optical coupling resin and wherein the filter portion is formed from a material mixed with the optical coupling resin.

5. The scintillator of claim 1, wherein the scintillator portion comprises a pixelated structure with a plurality of pixels and a gap between adjacent pixels, the filter portion provided within the gaps.

6. The scintillator of claim 1, wherein the filter portion is formed from a dye applied to the surface of the scintillator portion, wherein the dye comprises a near-IR blocking dye.

7. The scintillator of claim 1, wherein the filter portion is formed from one of a powder, dispersion, or solution deposited on the surface of the scintillator material portion, wherein the powder, dispersion or solution has a near-IR blocking property.

8. The scintillator of claim 1, wherein the filter portion is formed from one of a pigment, a nanomaterial of one or more noble metals, semiconductor nanocrystals, or an oxide containing solution gel (sol gel) suspensions, wherein the pigment, the nanomaterial of one or more noble metals, the semiconductor nanocrystals, or the oxide containing sol gel suspensions has a near-IR blocking property.

9. The scintillator of claim 1, wherein the filter portion is formed from a material that reduces afterglow from the scintillator material.

10. The scintillator of claim 1, wherein the filter portion is disposed on the surface of the scintillator portion without changing the material structure of the scintillator portion.

11. The scintillator of claim 1, further comprising a support structure configured to couple the scintillator to a computed tomography (CT) system.

12. The scintillator of claim 1, wherein the filter portion comprises a frequency pass filter device.

13. A computed tomography (CT) imaging system comprising:
a gantry configured to rotate about a center of rotation;
a detector assembly coupled to the gantry, the detector assembly comprising a plurality of detectors, wherein the detectors comprises scintillators having a scintillator a scintillator material portion formed from a base scintillator material, a photodetector, and a filter portion comprising a material blocking near-infrared (IR) emissions, the filter portion disposed on a surface of one of the scintillator material portion or the photodetector, wherein the scintillator material portion, the photodetector, and the filter portion are coupled together, and the filter portion blocks the near-IR emissions from impinging on the photodetector formed from a base scintillator material;
an x-ray source coupled to the gantry that projects a beam of x-rays toward the detector assembly; and
an image reconstructor configured to receive x-ray data from the detector assembly and reconstruct images using the received x-ray data.

14. The CT imaging system of claim 13, wherein the filter portion of the scintillator is formed from a material that blocks emissions outside of a frequency range of approximately 450 nanometers (nm) to approximately 700 nm.

15. The CT imaging system of claim 13, wherein the filter portion of the scintillator is formed from a material that blocks emissions outside of a Ce³⁺ emission range.

16. The CT imaging system of claim 13, wherein the scintillator portion of the scintillator further comprises an optical coupling resin and wherein the filter portion is formed from a material mixed with the optical coupling resin.

17. The CT imaging system of claim 13, wherein the scintillator portion of the scintillator comprises a pixelated structure with a plurality of pixels and a gap between adjacent pixels, the filter portion provided within the gaps.

18. The CT imaging system of claim 13, wherein the filter portion of the scintillator is formed from a dye applied to the surface of the scintillator portion, wherein the dye comprises a near-IR blocking dye.

19. The CT imaging system of claim 13, wherein the filter portion of the scintillator is formed from a material that reduces afterglow from the scintillator material.

20. The CT imaging system of claim 13, wherein the filter portion of the scintillator is disposed on the surface of the scintillator portion without changing the material structure of the scintillator portion.

21. The CT imaging system of claim 13, wherein the filter portion of the scintillator comprises a frequency pass filter device.

22. A method for providing a scintillator, the method comprising:
providing a scintillator material portion formed from a base scintillator material;
providing a photodetector;
disposing a filter portion on a surface of one of the scintillator material portion or the photodetector, the filter portion comprising a material blocking near-infrared (IR) emissions; and
coupling the scintillator material portion, the photodetector, and the filter portion together, and wherein the filter portion blocks the near-IR emissions from impinging on the photodetector.
